(19) United States
(12) Patent Application Publication
(10) Pub. No.: US 2006/0172802 A1
(43) Pub. Date: Aug. 3, 2006

(54) Multi-function wireless adapter system for game console

(76) Inventors: Saied Hussaini, Miami, FL (US); Marc Iacovelli, Miami, FL (US)

Correspondence Address: LINIAK BERENATO & WHITE, Suite 240, 6550 Rock Spring Drive, Bethesda, MD, 20817, US

(21) Appl. No.: 11/326,611

(22) Filed: Jan. 6, 2006

Related U.S. Application Data
(63) Continuation-in-part of application No. 11/071,591, filed on Mar. 4, 2005.
(60) Provisional application No. 60/647,800, filed on Jan. 31, 2005.

(51) Int. Cl. A63F 9/24; G06F 19/00

(52) U.S. Cl. 463/39

(57) ABSTRACT

A wireless control unit includes a controller having wireless transmitter circuitry for transmitting game information, and a single console interface/adapter for converting a plurality of the communication ports of the game console into wireless receivers/transmitters. A single console interface/adapter converts multiple game console ports. The console interface/adapter may also includes an additional communication port (i.e., pass-through) so as to provide the user with access to the used communication port while the interface/adapter is operably disposed within the communication port of the game console.

The instant application is a continuation-in-part application of U.S. Ser. No. 11/071,591 filed Mar. 4, 2005 which claims domestic priority to U.S. provisional application 60/647,800 each of which are hereby incorporated herein by reference and claimed as priority.

### FIELD OF THE INVENTION

The present application generally relates to wireless electronic device controllers and accessories therefor. More particularly, the invention relates to wireless electronic device control units incorporating dual-transmitter/receiver adapters for the game console.

### DESCRIPTION OF THE RELATED ART

Home video game systems generally have a game console coupled to a television monitor and one or more game controllers connected to the console which permit user interaction with a game being played. Most video game systems are sold with game controllers that are connected to the console through a hard-wire link. More recently, wireless game controller accessories have been developed which provide players with more freedom of movement. Such wireless controller accessories replicate the basic control features found on conventional hard-wired controllers but use infrared (IR), radio frequency (RF) or other electromagnetic radiation to send signals to the console.

To operate the video game system, a user (or player) inserts a game program which may be stored in a game cartridge or on a compact disc into the console and typically depresses a start switch to begin play of the particular game programmed into the cartridge or on the compact disc. As a game is played, a player or players control various visual aspects of the game using either the hard-wired or wireless controllers. For example, certain video games allow players to maneuver persons or aliens over various types of terrain, through tunnels, under water and over other various obstacles in order to score points. Some of these video gaines allow players to fly planes, helicopters, tanks and the like to attack various installations and score points. Other video gaines allow players to maneuver a person and to fire weapons at program generated images or at images of a person controlled by another player. All of these video aspects of the gaming industry are well known to those of skill in the art.

Some current wireless game controllers communicate with a console interface that communicates with the game console through a game port designed to receive a communication cable. The console interface (i.e., an adapter) plugs into the game port and transmits and receives control signals to and from a plurality of wireless controllers. Conventional console interfaces are limited to communication with a single player and are limited in their connection techniques with the game console.

The need exists for a more versatile multi-function console interface for converting wired communication ports to accommodate wireless communication with more than one game controller.

### SUMMARY OF THE INVENTION

The present application provides various embodiments of wireless game control units including a multi-function game console interface that interfaces with more than one communication port on a game console to convert the plurality of game ports to transmit and receive signals in a wireless manner.

In one embodiment, the wireless control unit includes (1) at least two controllers each having at least one user operable switch and each having wireless transmitter circuitry for transmitting game information and (2) a multi-function console interface/adapter having wireless receiver circuitry for receiving the game information from both of the controllers and for modifying the game information so that the game information signal is sent from the console interface to the console through the appropriate console game port.

The multi-function console interface/adapter is configured to provide an adaptable connection with the game ports of the game console. In addition, the circuit board of the multi-function interface/adapter is designed and configured to discriminate the signals received from a plurality of wireless controllers.

These and other benefits of the present invention will be apparent to those of skill in the art from the following description and associated drawings.

### BRIEF DESCRIPTION OF THE DRAWINGS

FIG. 1 is a block diagram of a video game system incorporating a wireless controller unit according to the present invention;

FIG. 2 is a side-elevational view of a controller for the wireless control unit according to the present application;

FIG. 3 is a top view of the controller of FIG. 2;

FIG. 4 is a front elevational view of the controller of FIG. 2;

FIG. 5 is a block diagram of transmitter/receiver circuitry for the controller of FIG. 2;

FIG. 6 is a block diagram of transmitter/receiver circuitry for the console interface of the wireless controller unit;

FIGS. 7-9 is an illustration of one embodiment of the transmitter/receiver adapter according to the present invention:

FIG. 10 illustrates an alternate embodiment of the present invention.

### DETAILED DESCRIPTION OF THE PREFERRED EMBODIMENTS

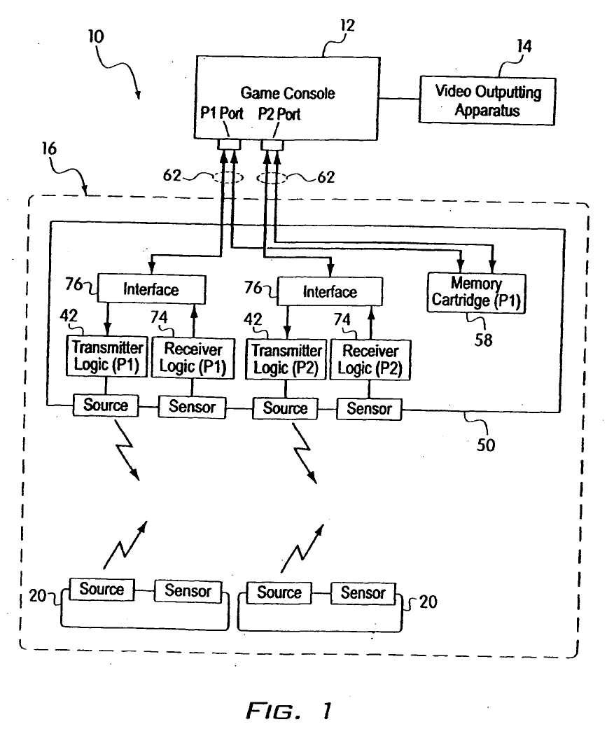

The present application provides a wireless control unit for video game systems including a dual-function transmitter/receiver adapter incorporated into the wireless control system. Preferably, the wireless control unit transfers game information by radio frequency (RF) transmissions. However, other known electromagnetic radiation techniques, such as infrared (IR) transmissions, may be employed. In accordance with other embodiments (to be discussed later), the combined use of IR and RF wireless communication protocols provides superior communication results between a game controller and a game console. Referring to FIG. 1, an exemplary embodiment of a video game system incorporating the wireless control unit of the present application is shown. In this embodiment, the video game system 10 includes a game console 12, a video outputting device 14, such as a television monitor, and the wireless control unit 16. The game console 12 includes a housing having at least one controller (or game) connection port and a game cartridge port. A game cartridge has a video game program stored therein. Alternatively, the console 12 may include a disc drive mechanism in which a disc, such as a compact disc, has stored thereon a video game program.

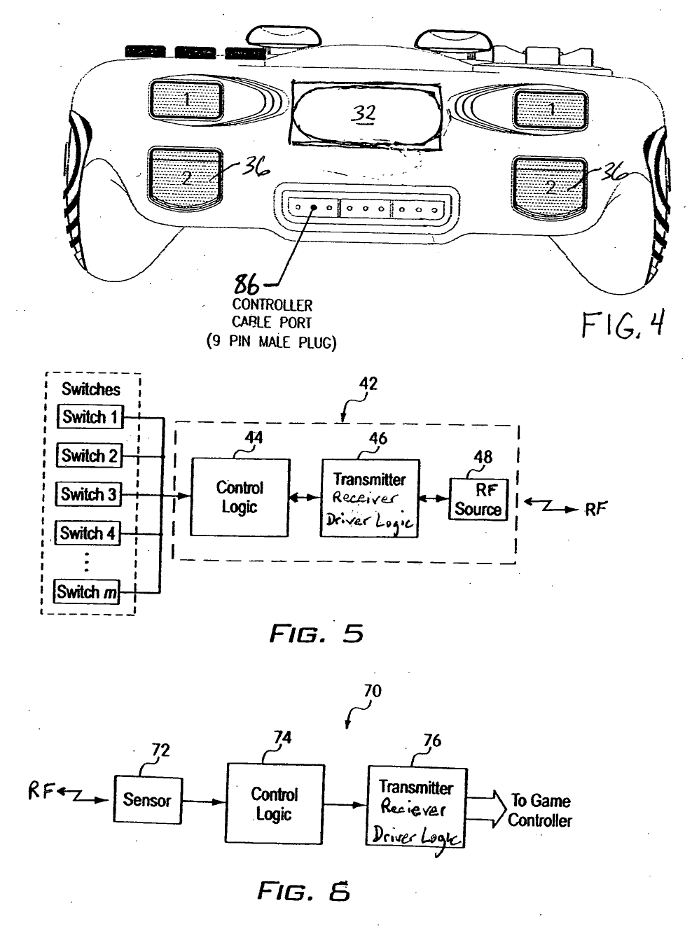

Referring to FIG. 1, the wireless control unit 16 according to the present application includes a pair of controllers 20 and a single console interface 50. The plurality of controllers 20 and the single console interface 50 are configured for bidirectional wireless communication. For bidirectional wireless communication, the controllers 20 and the console interface 50 both would include the transmitter logic 42 (shown in FIG. 5) and the receiver logic 70 (shown in FIG. 6). The transmitter and receiver circuitry for each player playing a game would operate at different frequency bands (or use different coding schemes). Information transmitted from the controller to the console interface includes game information, and information from the console interface to the controller includes information to, for example, reconfigure the functions of the switches and information that provides interaction between the controller and a game being played. The information from the console interface to the controller is collectively defined as controller information. Thus, the controller can include a connection port 86 (seen in FIG. 4) for connecting different peripheral devices to the controller which are responsive to the controller information transmitted by the console. Such peripheral devices include memory cartridges, vibrating members (e.g., a rumble pack), and other devices that can respond to controller information transmitted by the console.

The game console 12 also includes known circuitry for executing the video game program stored in the cartridge or on disc. For example, the console may include a processor, memory and stored system programs for controlling the operation of the console, controller interface circuitry, and audio/video generating and outputting circuitry. An example of suitable game consoles are included in the Nintendo N64®, Xbox®, SEGA Genesis and Sony Playstation®, and Playstation II® game systems. In the video game system 10 according to this embodiment of the present invention, the console 12 is connected to a video outputting apparatus 14 via a direct wire link. Further, the wireless control unit 16 can be connected to the console by, for example, a direct wire link or by mating connectors.

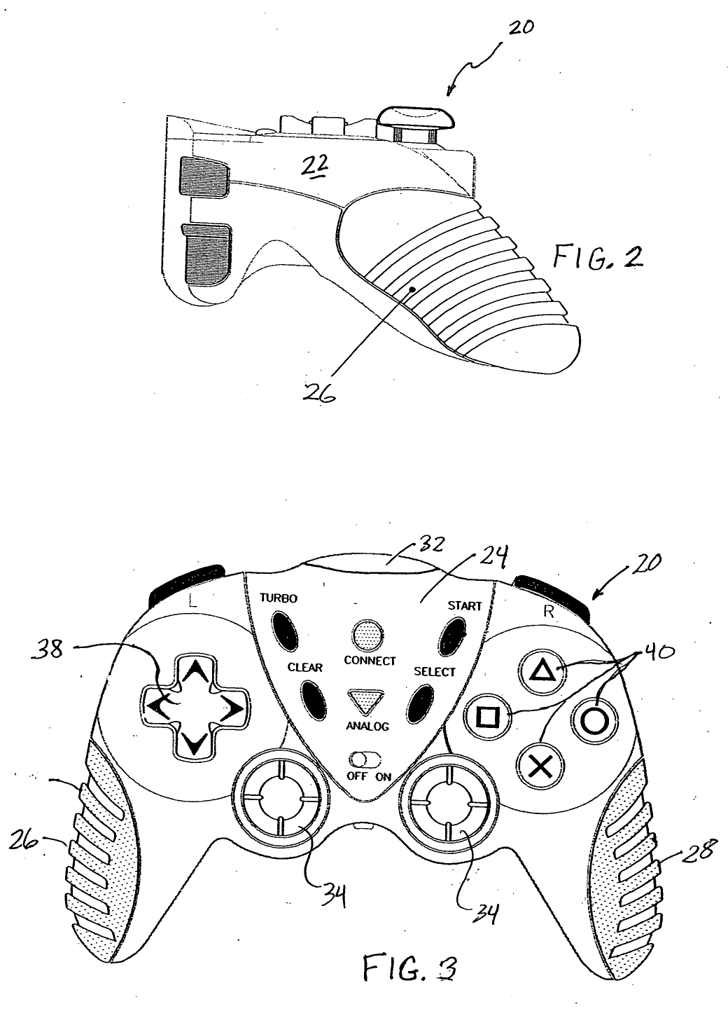

As seen in FIGS. 2-4, the controller 20 has a housing 22 defined by a central control section 24, left and right side handles 26, 28 extending out from the central control section 24 and then angled downwardly. Since in this embodiment signals are transmitted from the controllers 20 to the single console interface 50 via radio frequency (RF), the housing 22 preferably includes a transmission window 32 for emitting RF signals. However, if the transmission of control information from the controller 20 to the console interface 50 is by other electromagnetic radiation techniques then a transmission window may not be necessary. A plurality of user activated switches 40 are mounted to the housing 22 and accessible from outer surface portions of the housing 22. The controller 20 also includes a battery (not shown) that supplies power to the internal components of the controller.

Typically, a player grips the side handles 26, 28 during play and operates the switches corresponding to the handles gripped, where rocker switch 38 and push-button switches 40 are the user activated switches. Rocker switch 38 can be used for two or three dimensional movement of an object controlled by the controller 20 and push-button switches 40 can be used for performing control functions associated with the object. Further, the orientation of the switches 40 and the three handle configuration of the controller 20 also facilitates single handed as well as two handed gripping and operation of the controller by a player. For single handed gripping and operation, a player can grip the center handle 30 and joysticks 34 and trigger switches 36 are the user activated switches. Joysticks 34 can be used for two or three dimensional movement of an object controlled by the controller 20, and trigger switch 36 can be used for performing at least one control function associated with the object. In this embodiment, trigger switch 36 is typically used to fire weapons during a game.

Referring to FIG. 5, the controller 20 includes transmitter/receiver circuitry 42 operatively connected to the various switches, which sends and receives game information from the switches, formats the game information into, for example, bit streams for wireless transmission, and transmits the game information to the console interface 50. The transmitter/receiver circuitry 42 includes control logic 44, transmitter/receiver driver logic 46 and at least one transmitter source 48. The control logic 44 receives the game information from the various switches, and encodes the game information into, for example, a serial bit stream which is suitable for wireless transmission preferably by infrared. The bit stream may be configured such that one or more bits in the stream represent one switch on the controller 20. The transmitter circuitry 46 receives the bit stream from the control logic 44 and amplifies (if necessary) and modulates the bit stream at a predefined frequency band (e.g., 38 kHz) to energize at least one infrared source 48 (e.g., an LED) which emits infra-red signals.

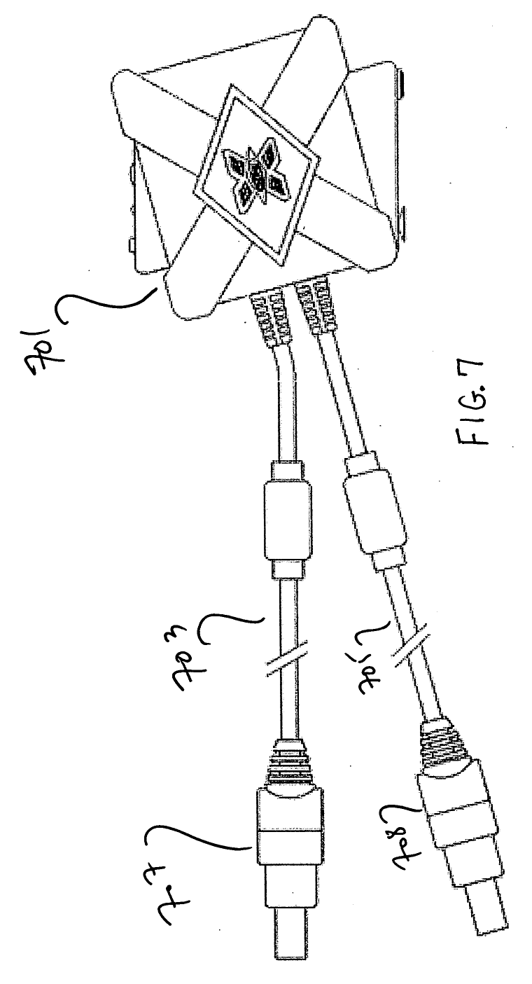

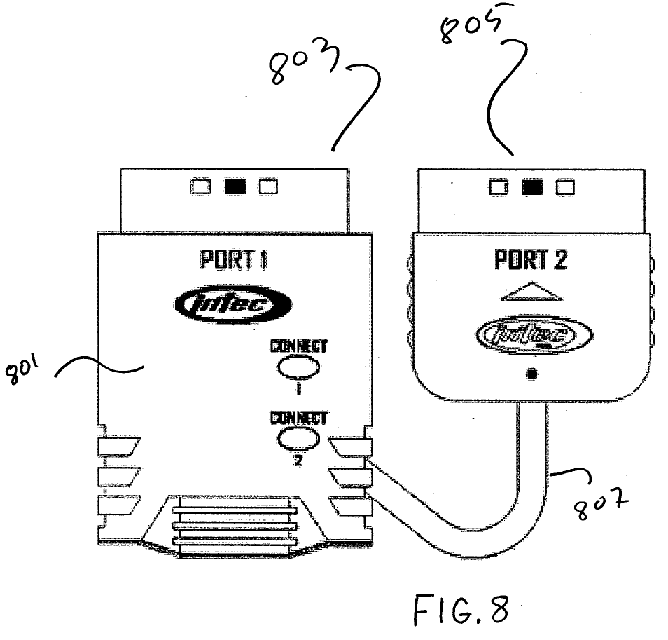

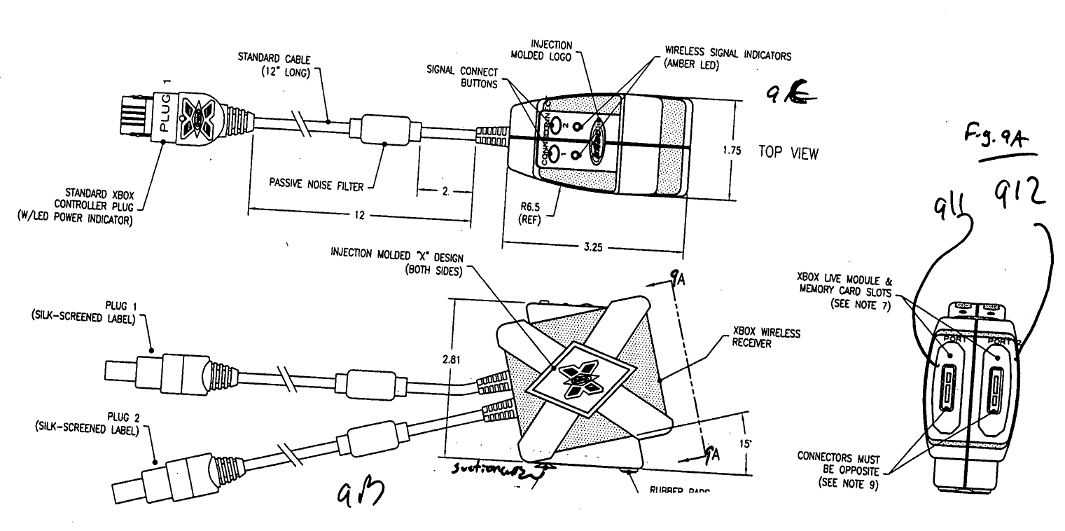

Referring to FIG. 6, the console interface 50 also includes transmitter/receiver circuitry 70 that receives the transmitted bit stream, extracts the game information from the bit stream, formats the game information into a form suitable for processing by the game console 12, and transfers the game information to the game console 12. More particularly, in an IR embodiment, the receiver circuitry 70 includes a sensor 72, such as a photosensitive transistor, which receives the infrared signals from the controller 20, and receiver logic 74 that amplifies the received bit stream, demodulates the amplified bit stream and decodes the game information from the bit stream. Console interface logic 76 then formats the game information for transfer to the game console 12 via, for example, cable 62 (FIGS. 7 and 8). In a contemplated RF embodiment, sensor 72 would be an RF antenna. The embodiment of FIG. 7 includes a central portion 701 containing the internal transmission/reception circuitry and the control logic, and two flexible cables 703/705 leading to separate connectors 707/708 with appropriate pin out arrangement for connection to an X-Box gaming console. The embodiment of FIG. 8 includes two connectors 803, 805 interconnected by a single flexible cable 807. The transmission/reception circuitry and control logic are contained within a portion 801 of the first connector 803 assembly formed of a substantially unitary body. The flexible cable 807 providing the ability to establish connection between the connectors 803,805 with the gaming console (such as the Playstation II™) and accommodate tolerances in sizing between the connection portions of such consoles as well as varied generations within a gaming platform.

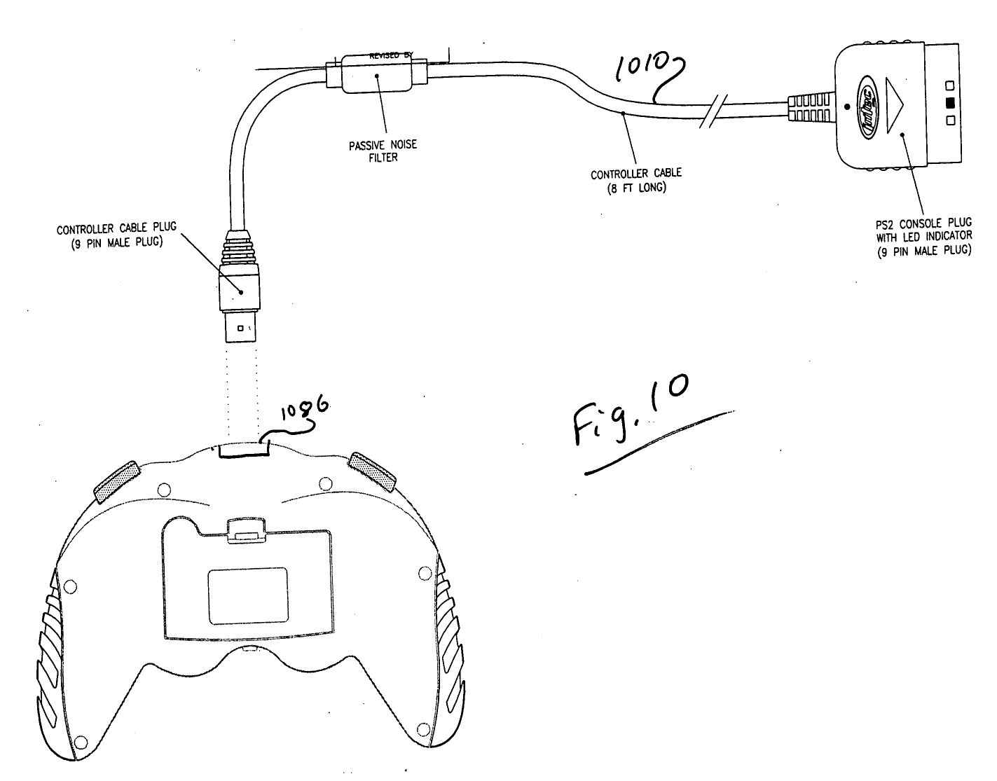

FIGS. 9a -9b additional advantages to the connector of FIG. 7. FIG. 9b is substantially the identical console interface of FIG. 7. However, as can be seen in FIGS. 9A, the console interface includes a pair of memory/expansion portions integrated into the central console portion. Because the connectors 707/708 occupy the expansion portion of the gaming console, the ports 911, 912 serve to establish connection of such devices while utilizing the wireless console interface. The internal circuitry can either integrate the control communication between the ports 911, 912 and the console, or selectively allow a bypass or direct communication for the memory port or peripheral device with the console. The overall arrangement facilitates the ability to convert the gaming console to a wireless adapter while maintaining the expansion/memory connection with the ports.

FIG. 10 represents an alternate embodiment of FIGS. 8/4. In such an arrangement the controller includes an auxiliary controller portion connection 1086 to allow direct wired connection between the console and controller via conventional releasable cable 1010. When batteries are depleted in the controller, a user may maintain the ability to play by simply connecting directly to the gaming console. A passive noise filter is also included in the cable 101 0 to facilitate clean transmission of control signals between the console and controller.

While the present invention has been shown and described with reference to specific embodiments forming the best mode, various changes in form and detail may be made without departing from the spirit and scope of the invention.

1. A wireless game control unit for a video game system having a game console, the game console having a plurality of game controller ports, the wireless game control unit comprising:
a controller having at least one user operable switch and wireless transmitter circuitry for transmitting game control information to the receiver in the game console and wireless receiver circuitry for receiving controller information;
a wireless adapter having a built-in connector that is directly connected to the game console via the plurality of game controller ports and having wireless transmitter circuitry for transmitting the controller information to the wireless receiver in said controller,
wherein said wireless adapter comprises a plurality of connectors for connection to said plurality of game controller ports said connectors being moveable relative to one another to accommodate game controller ports at different locations.

2. The wireless game control unit according to claim 1, further comprising a game controller port disposed on said wireless adapter for providing a user with pass-through access to the used game controller port while said wireless adapter is disposed in the at least one game controller port on the game console.

3. The wireless game control unit according to claim 1, further comprising power supply means for supplying power to said wireless transmitter circuitry.

4. The wireless game control unit according to claim 3, wherein said power supply means comprises batteries contained within said wireless adapter.

5. The wireless game control unit according to claim 1, wherein said controller comprises an internal vibration member, said controller information including signals for selectively activating said internal vibration member in response to action within a game being played.

6. The wireless game control unit according to claim 1, wherein said wireless adapter further comprises a memory slot adapted to receive a memory card for expanding memory capabilities of the game console.

7. A wireless adapter for a video game system having a game console, the game console having game controller ports for sending and receiving game information to and from a wireless hand-held controller, the wireless adapter comprising:
a plurality of built-in connectors adapted to be connected to the game console via a plurality of the game controller ports and having transmitter and receiver circuitry for wirelessly transmitting game information to and from said controller,

8. The wireless game control unit according to claim 7, further comprising an additional game controller port disposed on said wireless adapter for providing a user with an additional game controller port while said wireless adapter is disposed in the at least one game controller port on the game console.

9. The wireless game control unit according to claim 7, wherein said wireless adapter further comprises a memory slot adapted to receive a memory card for expanding memory capabilities of the game console.

10. The wireless game control unit according to claim 7, further comprising power supply means for supplying power to said wireless transmitter circuitry.

11. The wireless game control unit according to claim 10, wherein said power supply means comprises batteries contained within said wireless adapter.

12. A wireless game control unit for a video game system having a game console, the game console having at least one game controller port and an infrared (IR) receiver for receiving wireless IR signals, the wireless game control unit comprising:
a controller having at least one user operable switch and IR transmitter circuitry for wirelessly transmitting game control information to the IR receiver in the game console and radio frequency (RF) receiver circuitry for receiving controller information;
a wireless adapter having a built-in connector that is directly connected to the game console without wires via the at least one game controller port and having RF transmitter circuitry for wirelessly transmitting the controller information to the RF receiver in said controller.

13. The wireless game control unit according to claim 12, wherein said wireless adapter further comprises a memory slot adapted to receive a memory card for expanding memory capabilities of the game console.

14. The wireless game control unit according to claim 12, further comprising a game controller port disposed on said wireless adapter for providing a user with access to the used game controller port while said wireless adapter is disposed in the at least one game controller port on the game console.

15. The wireless game control unit according to claim 12, further comprising power supply means for supplying power to said wireless transmitter circuitry.

16. The wireless game control unit according to claim 15, wherein said power supply means comprises batteries contained within said wireless adapter.

17. A wireless game control unit for a video game system having a game console, the game console having at least one game controller port and a radio frequency (RF) receiver for receiving wireless RF signals, the wireless game control unit comprising:
a controller having at least one user operable switch and RF transmitter circuitry for wirelessly transmitting game control information to the RF receiver in the game console and infrared (IR) receiver circuitry for receiving controller information;
a wireless adapter having a built-in connector that is directly connected to the game console without wires via the at least one game controller port and having IR transmitter circuitry for wirelessly transmitting the controller information to the IR receiver in said controller.

18. The wireless game control unit according to claim 17, wherein said wireless adapter further comprises a memory slot adapted to receive a memory card for expanding memory capabilities of the game console.

19. The wireless game control unit according to claim 17, further comprising a game controller port disposed on said wireless adapter for providing a user with access to the used game controller port while said wireless adapter is disposed in the at least one game controller port on the game console.

20. The wireless game control unit according to claim 17, comprising power supply means for supplying power to said wireless transmitter circuitry.
